(19) United States
(12) Patent Application Publication
(10) Pub. No.: US 2026/0111810 A1
(43) Pub. Date: Apr. 23, 2026

(54) SYSTEM AND METHOD FOR STRENGTH ANALYTICS

(71) Applicant: Ingrid Regina Stabb, Moraga, CA (US)

(72) Inventor: Ingrid Regina Stabb, Moraga, CA (US)

(21) Appl. No.: 19/362,930

(22) Filed: Oct. 20, 2025

Related U.S. Application Data
(60) Provisional application No. 63/709,178, filed on Oct. 18, 2024.

(51) Int. Cl. G06Q 10/0631; G06Q 10/067

(52) U.S. Cl. CPC G06Q 10/063112; G06Q 10/0674

(57) ABSTRACT

A computer-implemented system and method for predicting, visualizing, and applying workplace strengths profiles are disclosed. The system includes a processor executing modules that: (i) map user-identified strengths and external data (e.g., LinkedIn, HR, team benchmarks) to one or more enneagram types; (ii) transform those types into prescriptive guidance, predictive insights, and adaptive developmental plans using machine-learning refinement; and (iii) generate dynamic visualizations of team strengths and “what-if” scenarios through a visualization analytics engine. The system continuously personalizes recommendations and action plans by learning from user data, organizational context, and proprietary prescriptive content.

### CROSS-REFERENCE TO RELATED APPLICATIONS

This application claims benefit to Provisional Application No. 63/709,178, filed Oct. 18, 2024, the contents of which are herein incorporated by reference.

### BACKGROUND OF THE INVENTION

### Field of Endeavor

The present invention relates to profiling systems and methods, and more particularly to systems and methods for enneagram strength analytics configured through machine learning to identify, refine, and deliver prescriptive content, simulations and prescriptive action planning to enhance individual, team, and organizational performance across application-specific contexts.

### Background of Related Art

Managers and organizations lack tools that enable them to easily identify, interpret, and apply workplace strengths by enneagram type or to map those strengths to actionable developmental content for individuals and teams. Traditional approaches make it difficult for managers to visualize how team dynamics shift when new members join or existing members leave, or to generate adaptive action plans that strengthen collaboration and organizational performance. Identifying and applying employee strengths is essential for aligning individual talents with collective goals, improving engagement, productivity, and retention. However, existing enneagram and strengths assessment systems are static, personality-first, and descriptive, offering limited prescriptive guidance and no predictive power for ongoing team development.

As can be seen, there is a need for a strengths analytics system configured to identify and map workplace strengths into enneagram classifications; compute and refine strengths scores; and adapt prescriptive content using algorithms and machine learning. Such a system should integrate multi-source data (including structured, behavioral, and unstructured inputs analyzed through natural language processing) and deliver dynamic, predictive insights and “what-if” simulations to guide individuals, managers, and organizations in real time.

### SUMMARY OF THE INVENTION

The present invention relates to systems and computer-implemented methods for predicting and applying workplace strengths profiles through integrated assessment, algorithmic analysis, and machine learning technologies.

In one aspect, the invention provides a system comprising at least one processor and at least one memory storing instructions that, when executed, cause the processor to perform operations including: providing strength assessments to users via user devices; receiving assessment responses and external data items associated with the users (third-party data from employers and social media); computing strengths scores and identifying top strengths; using an algorithmic scoring engine to map the top strengths to enneagram types and generates predictive indicators based on enneagram scores.

In another aspect, the invention provides a Machine Learning Refinement Engine configured to map user-specific enneagram scores and predictive indicators to a corpus of proprietary prescriptive content. The foundational prescriptive content originates from the author's work The 9 Points of Potential (Penguin Random House, Aug. 12, 2025) and serves as the initial training source for the system's generative and adaptive content model.

In embodiments, the Machine Learning Refinement Engine incrementally develops and expands a growing adaptive body of content modeled on the original proprietary framework. The engine applies learned associations and outcome feedback to generate, refine, and deliver continually improving, personalized, and actionable guidance content to user devices. Such adaptive content evolves over time based on accumulated user interactions, updated assessments, and feedback data, thereby enhancing the precision and contextual relevance of prescriptive recommendations delivered through the system.

In an additional aspect, the system stores user profiles containing strengths scores, top strengths, external signals and enneagram mappings; aggregates user profiles into hierarchical team-level profiles; refines user profiles and team profiles based on third-party data, behavioral feedback and machine learning, renders dynamic team graphs and recommends additional content items including sequenced development plans and tailored workplace guidance.

In a further aspect, the system provides interactive “what-if” simulation tools for modeling team composition changes and visualizing predicted shifts in strengths balance and collaboration outcomes.

In yet another aspect, the system incorporates reliability safeguards including drift detection, bias monitoring, and confidence scoring, wherein the Machine Learning Refinement Engine is retrained when these safeguards determine retraining is necessary by feeding data items to update the engine's parameters.

The invention enables organizations to optimize workforce performance by mapping strengths-assessment data to corresponding enneagram profiles and applying predictive analytics to generate and deliver personalized prescriptive content. In embodiments, the system maintains an increasingly refined and expanding database of actionable recommendations supporting individual development, team composition, and organizational action planning, with each cycle of use improving the accuracy and contextual relevance of the prescriptive content delivered to users.

### BRIEF DESCRIPTION OF THE DRAWINGS

FIG. 1 is a schematic diagram of a Strengths Analytics System, according to aspects of the present invention;

FIG. 2 is a flow diagram of a method of Strength Analytics, according to aspects of the present invention;

FIG. 3 is a diagram of an exemplary dynamic team graph, according to aspects of the present invention;

FIG. 4 is a flow diagram of a method of strength-based adaptive feedback, according to aspects of the present invention; and

FIG. 5 is a diagram of an enneagram diagnostic method, according to aspects of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Managers and organizations struggle to identify and apply the most impactful workplace strengths for improving teamwork, leadership, and communication. Existing tools provide limited visibility into how individual enneagram-based strengths translate into collective team dynamics or developmental priorities. Without systems capable of mapping strengths to prescriptive guidance, predictive insights, and “what-if” simulations, managers cannot easily forecast the effects of team composition changes or generate targeted action plans that enhance performance and collaboration across individual, team, and organizational levels.

Broadly, the present invention determines an individual's enneagram type, predictive developmental content, team impact and manager's optimal action plans, based on a new methodology and a unique taxonomy of 45 strengths, not found anywhere else other enneagram tests or strengths diagnostics as well as machine learning for ongoing customization of content delivery.

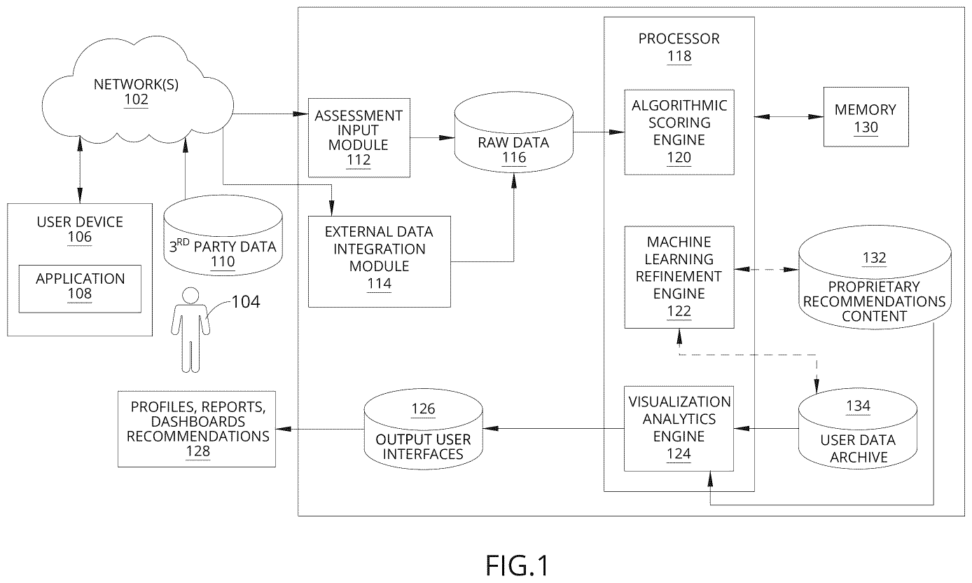

Referring to the Figures, FIGS. 1-5 illustrate aspects of a Strengths Analytics System and Method, according to aspects of the present invention.

FIG. 1 illustrates a schematic diagram of a Strengths Analytics System, according to aspects of the present invention. Broadly, and described in more detail hereinafter, the Strengths Analytics System of the present invention includes one or more computing devices, or computers, such as a user device 106 running one or applications, computer programs, or modules, such as application 108, and Device 100 having a processor 118, and memory 130, storing one or more applications, computer programs, or modules, configured to interaction with one another utilizing a communications network 102. In embodiments, user device 106 and device 100 can be separate devices, or the same device, and functionalities shown therebetween can be implemented in a singular device.

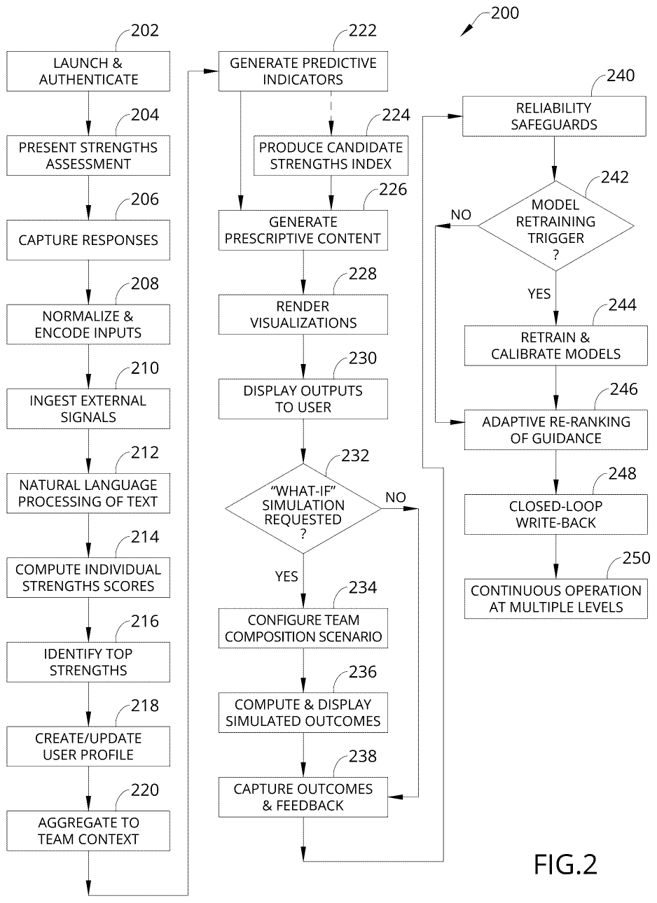

The Strengths Analytics System includes a plurality of applications, computer programs, modules, or engines configured to perform functionalities of the system, such as: an Input Assessment Module 112, an Algorithmic Scoring Engine 120, a Machine Learning Refinement Engine 122, a Visualization Analytics Engine 124, and/or an External Data Integration Module 114. In addition, the Strengths Analytics system includes one or more data sources, such as one or more third-party data sources 110, a raw data store 116, a content recommendation store 132, a user archive 134, and/or a user output store 126. In embodiments, the Strengths Analytics System operates to receive inputs from a user, process the inputs using one or more of the applications, and provide one or more profiles, reports, dashboards, and/or recommendations 128. Operation of the system is further described with respect to FIG. 2.

FIG. 2 illustrates a method of Strength Analytics 200 performed by the system of the present invention. Method 200 provides a strengths Analytics assessment for a user.

Method 200 begins at step 202 with launch and authentication, wherein one or more user(s) access application 108 running on user device 106 and authenticate using one or more credentials (i.e. login name, password, pin, etc.).

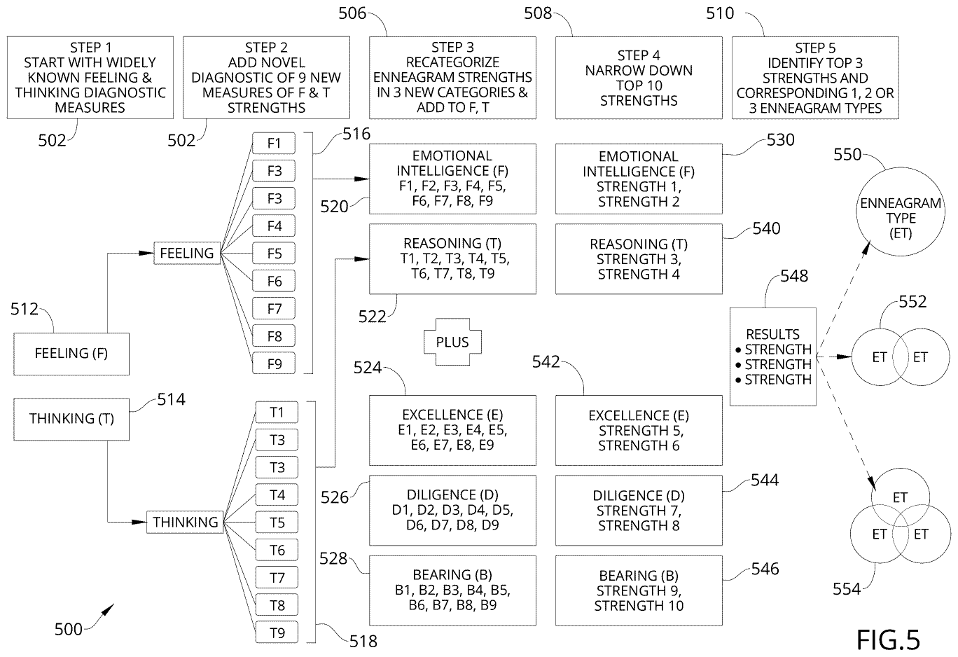

In response to authentication, at step 204 application 108 provides a strengths assessment to the user(s), described further with respect to FIG. 5. In embodiments, the strengths assessment includes one or more questions having one or more selectable responses. In embodiments, the one or more selectable responses are formatted as one or more of text, and/or rating(s), as described with respect to FIG. 5. In embodiments, the one or more questions are aligned to a taxonomy of set amount of workplace strengths (i.e. workplace strengths), as described further with respect to FIG. 5.

At step 206, application 108 captures one or more responses from the user(s) in response to the one or more questions, as described further with respect to FIG. 5. In embodiments, the one or more responses are one or more of the selectable responses.

At step 208, the captured one or more responses are normalized and encoded for further processing. In embodiments, application 108 transmits the captured one or more responses to device 100 for processing by Assessment Input Module 112. In embodiments, Assessment Input Module 112 converts the captured one or more responses into normalized variables and assigns weighted coefficients. In embodiments, the normalized variables and weighted coefficients are stored as a portion of raw data 116.

At step 210 one or more external data items are ingested into device 100 from one or more external data sources. In embodiments, the one or more external data items are associated with the user(s) answering the strengths assessment. In embodiments, External Data Integration Module 114 receives, retrieves, or fetches the one or more external data items for use by device 100. In embodiments, the one or more external data items include, but are not limited to, structured data, and/or unstructured data. In exemplary embodiments, the one or more external data items include, but are not limited to, benchmark data, job data, Human resources data, financial resource allocations by team, behavior data, resumes, comments, surveys, etc., associated with the user(s) answering the strengths assessment. In embodiments, External Data Integration Module 114 includes one or more sub-modules, or Application Programming Interfaces configured to extract the one or more external data items from external applications, and/or data sources (i.e. Microsoft Teams, Slack, LinkedIn, etc.). In embodiments, the one or more external data items are stored as a portion of raw data 116.

At step 212, any text data, such as unstructured text data, captured or ingested is transformed for use by device 100. In embodiments, a Natural Language Processor (NLP) transforms the text data into one or more embeddings. In embodiments, the one or more embeddings are aligned to strengths exemplars and/or role archetypes. In embodiments, the one or more embeddings are stored as a portion of raw data 116.

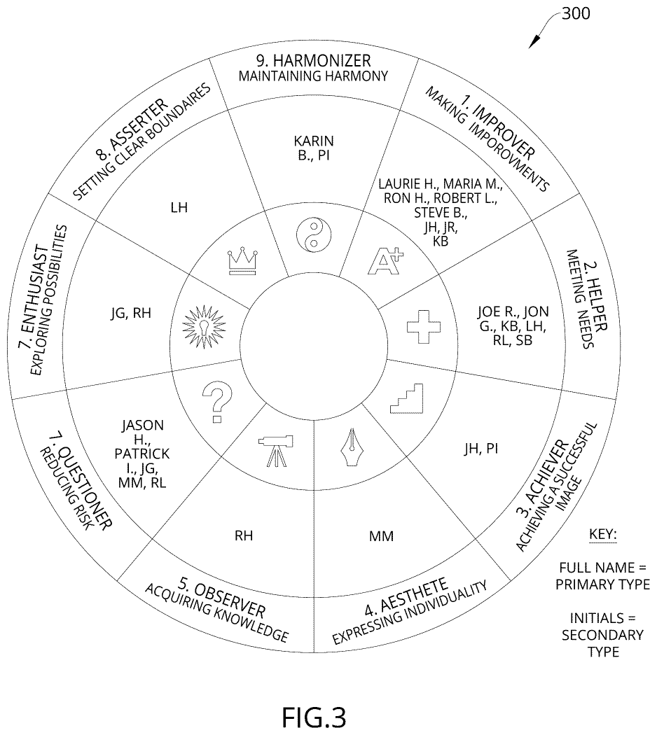

At step 214, one or more individual strengths scores are computed for the user(s) using data stored as raw data 116, as outlined with respect to FIG. 5. In embodiments, Algorithmic Scoring Engine 120 calculates these strengths scores based on normalized and encoded user responses and/or one or more external data items. For example, a user may interact with Assessment Input Module 102 via an application on a user device to identify three of the primary strengths shown in FIG. 5: T5 “complex thinking” 522, T9 “synthesizing information” 522, and F5 “sensitivity” 520. Based on these inputs, Algorithmic Scoring Engine 120 may determine that the user corresponds most closely with FIG. 3 enneagram types 5 (“Acquiring Knowledge”) and 9 (“Maintaining Harmony”). In some embodiments, External Integration Data Module 114 retrieves third-party data such as the user's job title, company name, team affiliation and financial resources of the team from systems such as LinkedIn or an enterprise HR database. This information is then associated with the user's profile and used by Algorithmic Scoring Engine 120 to enhance the precision of its scoring and mapping processes.

At step 216, three of the computed strengths scores are identified as top strengths for the user(s). In embodiments, Algorithmic Scoring Engine 120 selects the top strengths based on the highest scores or by applying a defined threshold. Once selected, the top strengths are mapped to one to three enneagram types, and in certain embodiments, are further used to generate predictive indicators and prescriptive content that provide the user with personalized insights and recommended actions based on the predicted enneagram-type classification.

At step 218, a user profile is generated and/or updated based on the outputs produced by Algorithmic Scoring Engine 120. In embodiments, the user profile includes strengths scores, the user's three self-selected top strengths, the corresponding mappings of those strengths to one to three enneagram types per user, and third-party contextual information including the user's job title, company name, team affiliation and financial resources of the team. These data elements are stored in a data repository, such as a database or file system. In embodiments, the data repository is implemented as User Data Archive 134, which maintains persistent storage of user profiles for subsequent analysis, refinement, and retrieval by other system modules.

At step 220, individual user profiles are aggregated to generate one or more hierarchical composite profiles for comparison and further processing. In embodiments, each user profile stored in User Data Archive 134 is combined into higher-level groupings such as team-level, department-level, and organization-level profiles. The aggregated data provide a basis for identifying group-level patterns in workplace strengths and enneagram-type distributions. For example, at the team level, the one to three enneagram types associated with each team member may be aggregated to produce a team strengths profile. In another example, multiple team strengths profiles may be further aggregated to produce a department strengths profile representing broader patterns within the organization. Such hierarchical aggregation enables meaningful comparative analysis across teams and departments.

These data are later utilized, as described with respect to step 228, to render visualizations and diagnostic dashboards. For instance, one team may show strong representation of T5 “complex thinking” 522, T6 “problem solving” 522, and T9 “synthesizing information” 522 strengths but lack E3 “public relations skills” 524. In comparison, another department may include both the T5, T6, and T9 strengths as well as E3 representation. This comparison may allow an organization to interpret why departments possessing the E3 strength are more effective in communicating accomplishments and securing additional financial resources. In embodiments, Algorithmic Scoring Engine 120 or a related analytics module compares such hierarchical profiles against benchmark data derived from raw data 116 to surface insights, identify gaps, and support organizational decision-making.

In one embodiment, the predictive strengths engine employs a machine-learning model configured to generate both predictive indicators and prescriptive content related to workplace strengths. The model is trained on linguistic and semantic patterns derived from the author's published work, The 9 Points of Potential (Penguin Random House, 2025). The training data are used to inform generative outputs that predict enneagram-type likelihoods and produce adaptive guidance for users, without reproducing or replicating verbatim text from the source material.

At step 222, one or more predictive indicators are generated based on user-level and aggregated hierarchical profile data. In embodiments, the predictive indicators are produced by providing individual user profiles and/or aggregated team and organizational profiles to Machine Learning Refinement Engine 122.

The system employs one or more Artificial Intelligence (AI) models, including but not limited to natural-language processing models, recommendation models, and predictive analytics models, to analyze strengths distributions and associated enneagram classifications. These AI models generate predictive insights such as collaboration tendencies, conflict-risk potential, communication patterns, and resource allocation efficiency at the individual, team, and organizational levels.

In embodiments, Algorithmic Scoring Engine 120 first maps each user's top strengths to one or more enneagram types and, based on those mappings, predicts areas where the user is likely to benefit from prescriptive advice and structured action planning. The output from the Algorithmic Scoring Engine 120 forms the input layer for the Machine Learning Refinement Engine 122, which synthesizes predictive indicators with contextual data to identify growth opportunities and development priorities.

Machine Learning Refinement Engine 122 then draws upon Proprietary Recommendations Content 132—a curated and continually expanding repository of strengths-based developmental guidance—to generate and refine prescriptive content. Over successive learning cycles, the engine applies adaptive weighting and feedback-driven optimization to deliver increasingly accurate, relevant, and personalized prescriptive recommendations to user devices.

This combination of predictive modeling and adaptive prescriptive content generation enables the invention to provide continuously improving, strengths-based guidance that evolves in precision and effectiveness with each iteration of user and organizational feedback.

Optionally, at step 224, one or more application-specific scores are computed for the user(s). In embodiments, the application-specific scores include, but are not limited to, a Candidate Strengths Index and/or a Weighted Fit Score.

The Candidate Strengths Index quantifies how closely a candidate's raw strengths scores and associated enneagram type align with desired strengths profiles for specific open job positions. In embodiments, the system maps the candidate's strengths data to third-party inputs—such as employer-defined role requirements, job-posting metadata, or desired strengths distributions maintained within external recruiting platforms or HR databases. The Candidate Strengths Index is calculated to indicate the degree of correspondence between the candidate's individual strengths profile and the desired strengths profile associated with a given position.

In exemplary recruiting applications, device 100 computes the Candidate Strengths Index and/or Weighted Fit Score based on custom organizational criteria. The resulting values provide recruiters and hiring managers with predictive insights into candidate-role alignment, supporting data-driven selection, placement, and workforce planning decisions.

At step 226, one or more personalized prescriptive content recommendations are generated and delivered to the user(s). In embodiments, this step provides tailored developmental guidance designed to help each user become more effective, successful, and fulfilled in the workplace.

Machine Learning Refinement Engine 122 selects and composes prescriptive recommendations from Proprietary Recommendations Content 132, drawing upon user-specific data such as strengths, enneagram-type mappings, hierarchical team associations, and accumulated feedback stored in User Data Archive 134. The prescriptive content is individualized for each user profile and is presented in the form of reports that (1) predict potential needs or weaknesses associated with the user's strengths and enneagram types and (2) provide actionable guidance and recommended next steps for professional growth.

The content forming the basis of these recommendations is derived from the conceptual framework and textual materials contained in The 9 Points of Potential (Penguin Random House, 2025). Textual patterns and semantic relationships from that publication are used to train the machine-learning model so that it can generate predictive insights and prescriptive narratives consistent with the author's strengths-based methodology.

For example, a user exhibiting the strength T5 “Complex Thinking” 522, based on mapping of this strength in Proprietary Recommendations Content 132, would be predicted by the Processor 118 to experience a workplace development area of social discomfort. In this embodiment, the prescriptive content provides personalized guidance with specific, actionable steps to reduce social discomfort, such as suggested communication techniques, collaborative practices, or environmental adjustments, thereby improving the user's overall workplace effectiveness.

In another example, the system based on the Proprietary Recommendations Content 132 would determine that an individual possessing the strength T5 “Complex Thinking”522 is unlikely to also possess the strength E3 “Public Relations Skills” 524. Conversely, an individual with the strength E3 “Public Relations Skills” 524, based on mapping of this strength in Proprietary Recommendations Content 132, would be predicted by the Processor 118 to experience a workplace development area of overly bragging. The personalized report for such an individual would include prescriptive content offering actionable advice on how to overcome tendencies toward excessive self-promotion and how to foster collaboration and team recognition instead.

Through these examples, the system demonstrates how predictive identification of needs and weaknesses, paired with personalized prescriptive guidance, forms the core functional advantage of the invention: a continuously learning platform that generates strengths-based, adaptive, and individually relevant content for workplace development.

At step 228, one or more visualizations are generated to represent analytical results derived from aggregated user and organizational data. In embodiments, Visualization Analytics Engine 124 produces these visualizations based on data ingested, calculated, and/or determined by device 100.

FIG. 3 illustrates an exemplary visualization of a team strengths profile. In the example shown, the team exhibits comparatively lower representation in enneagram types 3, 4, 5, 7, 8, and 9, while showing stronger representation in enneagram types 1 (“Making Improvements”), 2 (“Meeting Needs”), and 6 (“Reducing Risk”). This visualization enables managers and analysts to observe collective strengths and potential imbalances within the team.

In other embodiments, Visualization Analytics Engine 124 may generate visualizations representing multiple teams within a department or organizational unit. For example, a departmental-level visualization (not shown in FIG. 3) may display both the relative distribution of strengths and corresponding financial resources for each team. In such an instance, the visualization may reveal that a team with low representation of team members with enneagram type 3 (“Achieving Successful Image”) 300, and thus lower representation of the strengths E3 “Public Relations Skills” 524, possesses comparatively lower financial resources than teams exhibiting higher E3 representation. These comparative visualizations assist organizations in correlating team composition with performance or resource allocation outcomes.

In exemplary embodiments, Visualization Analytics Engine 124 produces one or more interactive outputs, such as team graphs, dashboards, benchmarking curves, or predictive overlays. The resulting visualizations may be stored for subsequent access or display within Output User Interfaces 126, enabling continuous review and refinement of team and organizational performance insights.

At step 230, one or more outputs 128 are provide to the user. In embodiments, the one or more outputs 128 include, but are not limited to Profiles, Reports, Dashboards, Recommendations, Scores, visualization, and/or other data ingested, computed, or determined by device 100. In embodiments device 100 provides the one or more outputs 128 to application 108, which renders the one or more outputs, such as, individual profiles, team views, predictive insights, and actionable recommendations, to the user.

At step 232, a determination is made as to whether a “What-if” Simulation is requested. If the simulation is requested, control flow is passed to steps 234-236. If the simulation is not requested, control flow is passed to step 238.

At step 234, a “What-If” simulation is initiated to model the effects of potential changes in team composition or organizational structure. In embodiments, this step is referred to as Configure Team Composition Scenario. A user may define one or more hypothetical scenarios by providing input parameters that modify team membership, adjust role assignments, or otherwise alter team configuration variables. Visualization Analytics Engine 124, in conjunction with Algorithmic Scoring Engine 120, processes these user inputs to prepare a simulation dataset for further computation.

For example, referring to FIG. 3, a “What-If” scenario may be configured to determine the potential impact on the depicted team if team member Karin B. were to leave. In this configuration, the system registers the removal of Karin B. as an input variable for subsequent computation in step 236.

In another exemplary scenario (not shown in FIG. 3), a user may configure a department-wide simulation in which members exhibiting Excellence 524 category strength E3 (“Public Relations Skills”) are redistributed more evenly across multiple teams. This configuration stage defines the parameters for the subsequent predictive simulation of team and departmental outcomes.

These configuration activities enable users to establish baseline and modified team models that can be analyzed in real time to forecast organizational impacts before actual personnel or structural changes occur.

At step 236, one or more simulated outcomes are computed and displayed based on the team composition defined in step 234. In embodiments, this step is referred to as Compute and Display Simulated Outcomes. Based on the user inputs, device 100 calculates or determines predicted strengths balances, collaboration dynamics, and related organizational indicators for the configured team or department.

Continuing the example of FIG. 3, the simulation computes the projected impact of removing Karin B. and updates the visualization to show a decrease in enneagram type 9 (“Maintaining Harmony”) strengths, as well as a secondary reduction in enneagram type 1 (“Making Improvements”), corresponding to Karin B.'s primary and secondary strengths (represented by the data points labeled Karin and KB in FIG. 3).

In another embodiment (not shown), the system may simulate the redistribution of Excellence 524 category strength E3 (“Public Relations Skills”) members across multiple teams and display the forecasted rebalancing of financial resources or performance indicators across those teams.

In embodiments, Visualization Analytics Engine 124 produces one or more real-time visual outputs, such as updated team graphs, performance indicators, or comparative dashboards. These outputs allow users to observe how hypothetical personnel changes affect the overall strengths distribution, collaboration potential, and organizational balance, thereby enabling data-driven forecasting and strategic workforce planning.

At step 238, the system captures one or more outcomes and feedback signals generated during or after user interaction with the predictive and prescriptive components of device 100. In embodiments, this step is referred to as Capture Outcomes & Feedback. The collected feedback enables continuous learning, refinement, and improvement of the predictive accuracy and prescriptive relevance of the system.

In embodiments, device 100 gathers downstream signals such as action adoption rates, satisfaction ratings, performance outcomes, or other behavioral indicators associated with implemented recommendations. These feedback signals are stored and analyzed to adjust machine-learning parameters and improve the alignment between predicted strengths and real-world user performance.

An important aspect of this feedback process is that individual users may re-take the strengths assessment multiple times over a defined period. The system automatically detects such reassessments and adjusts prior user data to refine individual and aggregated strengths profiles for more accurate and temporally relevant predictions. This iterative reassessment loop allows the system to learn from longitudinal user input and adapt to developmental or contextual changes.

Another feedback mechanism includes human confirmation of system outputs. For example, managers or team leads may review generated team strengths profiles and provide evaluative input regarding the perceived accuracy of individual or team-level predictions. Such human feedback is recorded as a training signal and may be incorporated into the Machine Learning Refinement Engine 122 to enhance model performance and contextual interpretation of team dynamics.

In exemplary embodiments, both automated and human feedback data are stored within User Data Archive 134 or a related training dataset repository, enabling the system to progressively increase the precision of its predictive indicators, prescriptive content, and visualization accuracy over time.

At step 240, one or more reliability safeguards are performed on the models of the Machine Learning Refinement Engine 122 and/or one or more outputs of device 100. In embodiments, the one or more reliability safeguards include running one or more of: drift detection, bias monitoring, and confidence scoring on current models and outputs.

At step 242, a determination is made, based on the one or more reliability safeguards, as to retrain the models, or not to retrain the models. If the one or more reliability safeguard indicate degradation or data shift, retraining is performed and control is passed to step 244; otherwise control is passed to step 246.

At step 244, if retraining or refinement is indicated, one or more machine-learning models are updated using newly available diagnostic results, external signals, user profiles, team profiles, user feedback, safeguard findings, or other data items generated or received by the system. In embodiments, this refinement process focuses on improving the accuracy, personalization, and contextual relevance of the prescriptive content delivered to users.

As additional data accumulate—such as repeated assessment results, evolving team compositions, or manager-provided feedback—the system incrementally learns which prescriptive recommendations produce the most effective outcomes for individuals, teams, and departments. Over time, these adaptive updates enable progressively more precise, tailored, and actionable guidance, ensuring that the recommendations align with each user's unique strengths profile and the organization's evolving context.

In exemplary embodiments, Machine Learning Refinement Engine 122 automatically adjusts internal parameters, content-selection logic, and delivery timing based on aggregated feedback and performance signals, thereby enhancing the predictive and prescriptive capabilities of device 100 with each refinement cycle.

At step 246, the one or more content recommendations are refined and/or re-ranked using the one or more additional inputs. In embodiments, the one or more content recommendations are re-ranked based on observed effectiveness and updated model predictions.

At step 248, a closed-loop feedback process is executed for the express purpose of enhancing the quality and personalization of prescriptive content delivery. The primary function of this process is to ensure that each cycle of user interaction contributes directly to improving the effectiveness, accuracy, and contextual relevance of future recommendations.

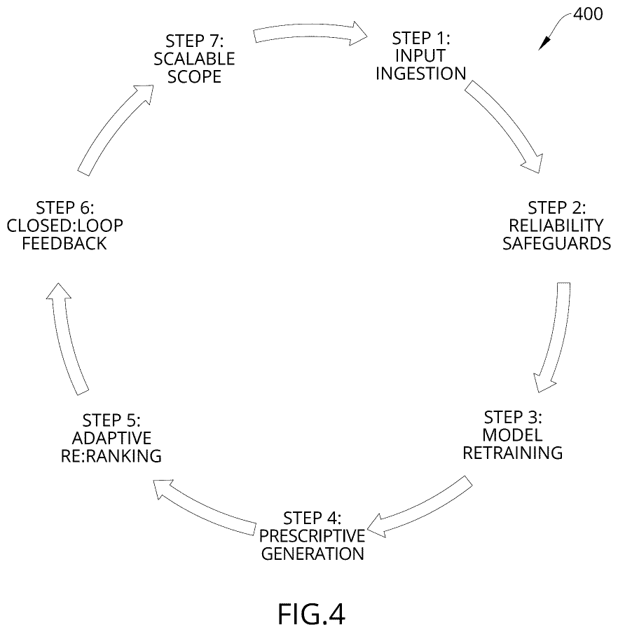

As illustrated in FIG. 4, the Strengths-Based Adaptive Guidance Loop depicts this continuous process, beginning with input ingestion and extending through reliability safeguards, model retraining, prescriptive generation, adaptive ranking, feedback capture, and scalable application—then returning to input ingestion to complete the adaptive loop.

In embodiments, device 100 records outcome signals, user engagement metrics, and verified feedback associated with prior prescriptive recommendations. These data are used to update Proprietary Recommendations Content 132 and User Data Archive 134, thereby refining how prescriptive guidance is prioritized, sequenced, and contextually delivered. The loop's central purpose is to create a self-optimizing feedback mechanism that learns from user outcomes and progressively improves the precision, timing, and usefulness of prescriptive recommendations provided to individuals, teams, and organizations.

At step 250, refinements generated through the closed-loop feedback process are propagated across all operational levels of the system to maintain continually improving prescriptive content delivery. Updates derived from the feedback cycle are integrated into User Data Archive 134, where they enhance both the personalization of user profiles and the contextual accuracy of recommendations at the individual, team, and organizational levels.

In embodiments, this continuous operation allows the invention to dynamically adjust its prescriptive guidance based on new assessment data, real-world feedback, and observed organizational outcomes. The system thereby aligns strengths-based development at the individual level with evolving team compositions and organizational objectives. Over time, this multi-level feedback propagation enables ever-improving prescriptive precision and impact, ensuring that the system delivers increasingly tailored, data-driven guidance that remains accurate, adaptive, and scalable in real-world use.

FIG. 3 illustrates an exemplary dynamic team graph 300, according to aspects of the present invention. Team graph 300 allows users to visualize and update, using device 300, aggregated strengths across multiple individuals and a visualization of the strengths one team possesses as team members join and leave the team. Team graph 300 includes a plurality of layer, including an outer layer, one or more middle layers, and an inner layer. In embodiments, method 200 determines one or more strengths of each team member, and maps the one or more strengths to enneagram types. In embodiments, the team graph 300 each layer is segmented by enneagram type with the outer layer listing the enneagram types (i.e. 1 “making improvements” improver, helper, achiever, artist, observer, questioner, enthusiast, asserter, harmonizer). The middle layer includes each team member listed, or displayed, within the enneagram type they were mapped to by method 200. The inner layer includes one or more icons, or interface elements, representing the enneagram type. In embodiments, device 100 produces team graph 300 in response to all or a portion of method 200.

FIG. 4 is a flow diagram illustrating a subset of the method steps shown in FIG. 2, specifically depicting the strengths-based adaptive feedback process 400, according to aspects of the present invention. FIG. 4 focuses on the adaptive guidance portion of the overall workflow described in FIG. 2, detailing how feedback signals, model retraining, prescriptive content generation, adaptive ranking, and closed-loop updates operate within the broader system framework.

FIG. 5 a diagram of a novel enneagram diagnostic method 500. In embodiments, method 500 is utilized to generate the prescriptive content delivery, dynamic visualizations and what-if scenarios utilized in method 200.

Method 500 begins at step 502 with feeling and thinking diagnostic measures being aggregated for a strength assessment. In embodiments, the feeling 512 and thinking 514 measures consist of known feeling and thinking diagnostic measures. At step 502, novel feeling measures 516 and novel thinking measures 518 are added to the strengths assessment. In embodiments, feeling measures 516 are emotional intelligence skills for a workplace across all the nine enneagram types that have not been identified in other enneagram tests. In embodiments, thinking measures 518 are logical thinking skills for the workplace across all the nine enneagram types that have not been identified in other enneagram tests. In embodiments, measures 516 and 518 are divided into 9 groups each across the 9 enneagram types.

At step 506, enneagram strengths are recategorized into 3 new categories, Excellence 524, Diligence 526, and Bearing 528, which are combined to the Emotional Intelligence 520, having the feeling measures 516, and Reasoning 522, having the thinking measures 518, and are provided to a user, such as user 104, as a strengths assessment, such as assessment 204.

At step 508, the user provides responses to the strengths assessment. In an exemplary embodiment the responses are captured by device 100, at step 206. In an exemplary embodiment, the responses are one or more strengths from categories 520-528, and are selected by the user. In the exemplary embodiment, user selection is guided by one or more distinguishing questions.

For example, the user can select one or more strengths from Emotional Intelligence 520, preferably two strengths, guided by the question associated with the strength. In the exemplary embodiment, strength F1 Courteousness is guided by the question: To what degree do I strive to remain dignified and gracious when relating to others, to be included as a good team player, to be a good listener, and to be a good communicator? Strength F2 Expressiveness is guided by the question—How do I rate my ability to successfully communicate emotions or ideas to people? Strength F3 Ability to Inspire is guided by the question-How effective am I at getting others to go beyond their former limitations? Strength F4 Compassion is guided by the question—To what degree do I resonate deeply with the feelings of others? Strength F5 Sensitivity is guided by the question—How would I rate my kindness and/or responsiveness to refined expressions of feelings in others, or in literature or art? Strength F6 Identifying with Others is guided by the question—To what degree do I relate to certain people (or animals) by putting myself in their position? Strength F7 Social Networking is guided by the question—To what degree do I reach out to new people, stay informed by exchanging information among experts, and keep in regular contact with many associates? Strength F8 Protectiveness is guided by the question—How strong is my drive to help and defend others? Strength F9 Empathy is guided by the question—How well do I listen in order to understand and experience the feelings or attitudes of others?

For example, the user can select one or more strengths from Reasoning 522, preferably two strengths, guided by the question associated with the strength. In the exemplary embodiment, T1 Logical Thinking is guided by the question—How skilled am I in methodically identifying the facts of a situation? T2 Resourcefulness is guided by the question—When a new situation or problem arises, how do I rate my ability to solve it by using my knowledge, my own creative solutions, and/or my own intelligence? T3 Strategic Calculation is guided by the question—How easily am I able to predict an outcome by crunching the numbers, evaluating tactics, or assessing components of a strategy? T4 Intense Discernment is guided by the question—How do I rate my keenness of intellectual (or emotional, or spiritual) perception? T5 Complex Thinking is guided by the question How is my capacity to comprehend complicated information? T6 Problem Solving is guided by the question—How skilled am I in working out solutions to difficult questions or problems? T7 Multidisciplinary Thinking is guided by the question—To what degree do I use diverse skills, switch adeptly from one topic to another, and apply ideas from various sources to my work? T8 Clarifying is guided by the question—How skilled am I in determining facts and explaining the course of action that needs to be taken? T9 Synthesizing Information is guided by the question—What is my ability to research and look at information from a variety of sources, and relate them to one another within a broader perspective?

For example, the user can select one or more strengths from Excellence 524, preferably two strengths, guided by the question associated with the strength. In the exemplary embodiment, E1 Improvement is guided by the question—To what degree do I raise the standards of my individual work, move the group project ahead, and/or make the world a better place? E2 People Skills is guided by the question—How skilled am I at creating a pleasant environment, engaging in conversation, being diplomatic and/or persuading people of my point of view? E3 Public Relations Skills is guided by the question—How easy do I find it to promote myself and those I represent? E4 Authenticity is guided by the question—To what degree am I committed to my own sense of meaning and do I generate work entirely from my own vision? E5 Working Independently is guided by the question—To what degree am I self-directed, preferring to work on my own projects for long periods of time? E6 Taking Precautions is guided by the question—How watchful and proactive am I when it comes to avoiding possible injuries, losses, or mistakes? E7 Enthusiasm is guided by the question—To what degree do I infect others with my excitement at work? E8 Boldness is guided by the question—How bold are my competitive instincts or negotiation skills, including my willingness to engage in conflict when necessary? E9 Mediating is guided by the question—What is my ability to see others'points of view and, when needed, help people who disagree to find common ground?

For example, the user can select one or more strengths from Diligence 526, preferably two strengths, guided by the question associated with the strength. In the exemplary embodiment, D1 Meticulousness is guided by the question—What capacity do I have to do precise, thorough, and detail-oriented work to “polish the pearl”? D2 Perceptiveness is guided by the question—How alert am I when it comes to picking up insights and awareness about people, including when discussing complicated subjects? D3 Efficiency is guided by the question—How successful am I at accomplishing jobs quickly and with the minimum of effort? D4 Aesthetic Sense is guided by the question—To what degree am I a connoisseur of the arts or I curate things that are pleasing to the senses? How developed is my sensitivity to beauty, style, taste? D5 Ability to Focus is guided by the question—To what degree can I concentrate on a single activity? D6 Exactness is guided by the question—How do I rate my preference for being careful and/or rigorous about the details? D7 Seeking Challenges is guided by the question—How important is it to me to seek physically or mentally stimulating undertakings? D8 Self-Reliance is guided by the question—To what degree do I rely upon my own capabilities, judgments, and resources rather than on others'? D9 Capacity to Repeat is guided by the question—What is my tolerance for doing one thing over and over, and my ability to deliver consistency? For example, the user can select one or more strengths from Bearing 528, preferably two strengths, guided by the question associated with the strength. In the exemplary embodiment, B1 Responsibility is guided by the question—How much accountability am I willing to accept? B2 Reliability is guided by the question—How much can others depend on me to be responsible and to do what I say I will do? B3 Drive to Win is guided by the question—How much energy do I put into becoming a success? B4 Uniqueness is guided by the question—How open am I to experimenting with unique ideas or ways of doing things? B5 Objectivity is guided by the question—How impartial and non-judgmental can I be? B6 Skepticism is guided by the question—To what degree do I have a doubting or questioning mind? B7 Idealism is guided by the question—To what degree is my work guided by noble concepts, meaningful principles, or artistic vision? B8 Leadership is guided by the question—To what degree do I guide the group to decisions or make quick decisions when that is called for? B9 Teamwork is guided by the question—How well do I cooperate with the group and play my part to help the group as a whole achieve a common goal?

At step 510, once the user has selected one or more strengths from each of the categories 520-528, the user rates themselves in each of the one or more strengths selected. In embodiments, the user selects two strengths 530, 540-546, from each category, leaving 10 total strengths, and ranks each of the 10 total strengths on a scale. In embodiments, the scale can be numerical, i.e. 1-5, with 5 being the highest ranking and 1 being the lowest ranking. Using the ranking, the user identifies 3 top strengths 548, which are mapped to one or more enneagram types 550-554.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a non-transitory machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Generally, a computer will also include a communications device. The communication device can include hardware and/or software for generating and communicating signals over a direct and/or indirect network communication link. As used herein, a direct link can include a link between two devices where information is communicated from one device to the other without passing through an intermediary. For example, the direct link can include a Bluetooth™ connection, a Zigbee connection, a Wifi Direct™ connection, a near-field communications (“NFC”) connection, an infrared connection, a wired universal serial bus (“USB”) connection, an ethernet cable connection, a fiber-optic connection, a firewire connection, a microwire connection, and so forth. In another example, the direct link can include a cable on a bus network. An indirect link can include a link between two or more devices where data can pass through an intermediary, such as a router, before being received by an intended recipient of the data. For example, the indirect link can include a WiFi connection where data is passed through a WiFi router, a cellular network connection where data is passed through a cellular network router, a wired network connection where devices are interconnected through hubs and/or routers, and so forth. The cellular network connection can be implemented according to one or more cellular network standards, including the global system for mobile communications (“GSM”) standard, a code division multiple access (“CDMA”) standard such as the universal mobile telecommunications standard, an orthogonal frequency division multiple access (“OFDMA”) standard such as the long term evolution (“LTE”) standard, and so forth.

Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

It should be understood, of course, that the foregoing relates to exemplary embodiments of the invention and that modifications may be made without departing from the spirit and scope of the invention as set forth in the following claims.

What is claimed is:

1. A system for predicting and applying workplace strengths profiles and delivering personalized prescriptive content, comprising:
at least one processor and at least one memory storing instructions that, when executed by the processor, cause the system to:
(a) provide, to one or more user devices, a strengths assessment comprising one or more questions with one or more selectable responses;
(b) receive, from the one or more user devices, the one or more selectable responses to the strengths assessment;
(c) receive, from one or more external data sources, external data items associated with respective users;
(d) compute, using an Algorithmic Scoring Engine, strengths scores for each user based on one or more of: the one or more selectable responses or at least a portion of the external data items;
(e) identify, using the Algorithmic Scoring Engine, one or more top strengths for each user based on the strengths scores;
(f) map, using the Algorithmic Scoring Engine, the one or more top strengths of each user to one or more enneagram types;
(g) store, for each user, a user profile including at least a subset of: the strengths scores, the one or more top strengths, the one or more enneagram-type mappings, and the external data items;
(h) aggregate user profiles into hierarchical profiles comprising at least one of team-level, department-level, or organization-level profiles;
(i) generate, using a Machine Learning Refinement Engine, one or more predictive indicators based at least on the user profiles and/or the hierarchical profiles; and
(j) generate and output, using the Machine Learning Refinement Engine, personalized prescriptive content to the one or more user devices, the personalized prescriptive content comprising actionable guidance predicted to address user needs associated with the user's strengths and enneagram-type mappings.

2. The system of claim 1, wherein the Machine Learning Refinement Engine is trained on a proprietary corpus of prescriptive guidance and, over time, expands an adaptive body of content modeled on the proprietary corpus using outcome signals and feedback.

3. The system of claim 1, further comprising a Visualization Analytics Engine configured to generate interactive visualizations based on the hierarchical profiles, the visualizations including at least one of: team graphs, dashboards, benchmarking curves, or predictive overlays.

4. The system of claim 1, wherein the instructions further cause the system to:
(a) capture feedback signals comprising at least one of action-adoption rates, satisfaction ratings, performance outcomes, reassessment results, or human confirmations of accuracy;
(b) update User Data Archive entries and prescriptive-content rankings using the feedback signals; and
(c) operate a closed-loop feedback process that progressively refines prioritization, sequencing, and contextual delivery of the personalized prescriptive content.

5. The system of claim 1, further comprising reliability safeguards comprising at least one of drift detection, bias monitoring, or confidence scoring; wherein, responsive to a safeguard determination, the Machine Learning Refinement Engine is retrained using newly available diagnostic results, external signals, feedback, or hierarchical profiles.

6. The system of claim 5, wherein retraining comprises updating internal parameters, content-selection logic, and delivery timing of the Machine Learning Refinement Engine based on aggregated feedback and performance signals.

7. The system of claim 1, further comprising an interactive “what-if” simulation component configured to:
(a) receive inputs defining changes to team composition, role assignments, or other composition variables;
(b) compute predicted impacts on strengths distributions, collaboration dynamics, or resource indicators; and
(c) display updated visualizations reflecting the predicted impacts.

8. The system of claim 1, wherein the Machine Learning Refinement Engine composes reports that (i) predict potential needs or weaknesses associated with a user's strengths and enneagram-type mappings and (ii) provide sequenced, strengths-first action plans comprising actionable recommendations for professional growth.

9. The system of claim 1, wherein the instructions further cause the system to compute an application-specific score comprising a Candidate Strengths Index that maps a candidate's raw strengths scores and enneagram-type mapping to third-party desired strengths profiles associated with open job positions, and quantifies correspondence between the candidate's profile and a position's desired profile.

10. The system of claim 1, wherein the hierarchical profiles are compared against benchmark data to surface gaps in strengths distributions across teams or departments and to support data-driven resource allocation.

11. A computer-implemented method for predicting and applying workplace strengths profiles and delivering personalized prescriptive content, the method comprising:
providing, to one or more user devices, a strengths assessment comprising one or more questions with one or more selectable responses;
receiving the one or more selectable responses to the strengths assessment;
receiving one or more external data items associated with respective users;
computing, using an Algorithmic Scoring Engine, strengths scores for each user;
identifying, using the Algorithmic Scoring Engine, one or more top strengths for each user;
mapping, using the Algorithmic Scoring Engine, the one or more top strengths to one or more enneagram types;
storing a user profile for each user including at least a subset of strengths scores, the one or more top strengths, the one or more enneagram mappings, and the one or more external data items;
aggregating user profiles into hierarchical profiles;
generating, using a Machine Learning Refinement Engine, predictive indicators based on at least the user profiles and/or the hierarchical profiles; and
generating and outputting, using the Machine Learning Refinement Engine, personalized prescriptive content to the one or more user devices.

12. The method of claim 11, further comprising capturing feedback signals and operating a closed-loop feedback process that refines prescriptive-content prioritization, sequencing, and contextual delivery.

13. The method of claim 11, further comprising executing reliability safeguards comprising at least one of drift detection, bias monitoring, or confidence scoring, and, responsive thereto, retraining the Machine Learning Refinement Engine using updated diagnostic results, external signals, feedback, or hierarchical profiles.

14. The method of claim 11, further comprising generating interactive visualizations of team-, department-, or organization-level strengths distributions and predictive overlays.

15. The method of claim 11, further comprising performing “what-if” simulations by configuring team composition scenarios, computing predicted outcomes, and displaying updated visualizations reflecting changes in strengths balance, collaboration dynamics, or resource indicators.

16. The method of claim 11, further comprising composing reports that predict potential user needs or weaknesses associated with strengths and enneagram-type mappings and provide sequenced, strengths-first action plans comprising actionable recommendations.

17. The method of claim 11, further comprising computing a Candidate Strengths Index that maps a candidate's raw strengths scores and enneagram-type mapping to third-party desired strengths profiles associated with open positions and quantifies the correspondence therebetween.

18. A non-transitory computer-readable medium storing instructions that, when executed by one or more processors, cause performance of the method claim 11.
